(19) United States
(12) Patent Application Publication
(10) Pub. No.: US 2007/0180029 A1
(43) Pub. Date: Aug. 2, 2007

(54) Method and apparatus for restricting visual material for conference services

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/344,683

(22) Filed: Feb. 1, 2006

(51) Int. Cl. G06F 15/16

(52) U.S. Cl. 709/204

(57) ABSTRACT

A method and apparatus for restricting visual materials in conference services provided on networks such as the packet networks, e.g., Voice over Internet Protocol (VoIP) and Service over Internet Protocol (SoIP) networks are disclosed. For example, the customer subscribes to a service with integrated data and voice conferencing capabilities and collaboration services. In one embodiment, the service provider enables the subscriber of the service to create a list of participants for a conference call, to publish visual material to a web site shared by participants, and to restrict segments of the visual material to particular subsets of participants of the conference call.

The present invention relates generally to communication networks and, more particularly, to a method for restricting visual materials used in conference services provided on networks such as the packet networks, e.g., Voice over Internet Protocol (VoIP) and Service over Internet Protocol (SoIP) networks.

### BACKGROUND OF THE INVENTION

The Internet has emerged as a critical communication infrastructure, carrying traffic for a wide range of important applications. Internet services such as VoIP and SoIP are becoming ubiquitous and more and more businesses and consumers are relying on their Internet connections for staying connected and being able to conduct business at anytime from anywhere. For example, customers are using integrated voice and data services that enable them to share visual material during conference calls. However, during these calls a subset of the participants may need to view information in a private setting. For example, in a conference attended by multiple levels of management, some information may need to be restricted to only certain levels of management. Currently, participants leave the conference call, access collaboration services or convene in another private room, etc. to view the private material.

Therefore, there is a need for a method that integrates conference services and collaboration services, thereby enabling a host of the conference to post visual material to a shared web site while only allowing a specified set of participants to view certain segments of the visual material.

### SUMMARY OF THE INVENTION

In one embodiment, the present invention discloses a method and apparatus for restricting visual materials in conference services provided on networks such as packet networks, e.g., Voice over Internet Protocol (VoIP) and Service over Internet Protocol (SoIP) networks. For example, the customer subscribes to a service with integrated data and voice conferencing capabilities and collaboration services. The service provider enables the subscriber of the service to create and view a list of participants for a conference and to publish visual material to a web site shared by the participants. The service provider also enables the subscriber to restrict segments of the visual material to one or more particular subsets of participants of the conference. For example, the subscriber marks the visual material as either accessible by all participants or private. The subscriber then determines the subset of participants that may view that visual material marked as private.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with one embodiment of the invention for restricting visual material for conference services;

FIG. 3 illustrates a flowchart of the method for restricting visual material for conference services; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for restricting visual materials for conference services provided on networks such as the packet switched networks Voice over Internet Protocol (VoIP) and Service over Internet Protocol (SoIP). Although the present invention is discussed below in the context of VoIP and SoIP networks, the present invention is not so limited. Namely, the present invention can be applied for material shared on other networks such as the traditional telephone networks.

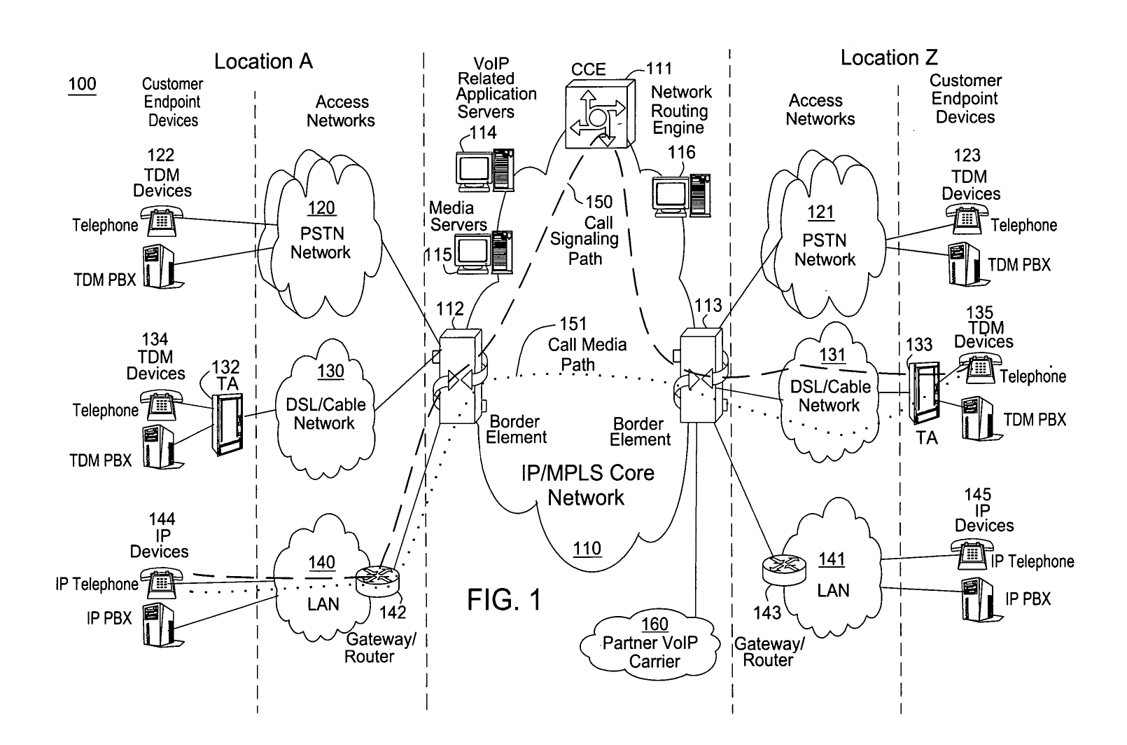

To better understand the present invention, FIG. 1 illustrates an example network 100, e.g., a packet network such as a VoIP network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

Media Servers (MS) 115 are special servers that typically handle and terminate media streams, and to provide services such as announcements, bridges, transcoding, and Interactive Voice Response (IVR) messages for VoIP service applications. The media servers also interact with customers for media session management to accomplish tasks such as process requests.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

The above network is described to provide an illustrative environment in which packets are transported and services are provided on packet networks such as VoIP and SoIP networks. Internet services are becoming ubiquitous and more and more businesses and consumers are relying on their Internet connections for conducting businesses and staying connected. For example, customers conduct conferences and reduce the time and cost involved in attending meetings in person. Occasionally, a group of participants need to collaborate on certain portions of the conference and need to share information. When the meeting is in person this can be accomplished by viewing private material in a separate room. When the meeting is on a conference call and visual material is being made available at a website, the private collaboration becomes difficult if not impossible. Participants are forced to leave the conference call and engage in another conference involving a subset of the participants. Therefore, there is a need for a method that enables, e.g., the host of the conference, to post visual material to a shared website and to allow a specified set of participants to view certain segments of the visual material marked as private.

In one embodiment, the current invention discloses a method and apparatus for restricting visual material for conference services provided on networks such as packet networks. In order to clearly illustrate the teachings of the current invention, the following terminologies and networking concepts will first be described:
Conference call;
Conference bridge;
Integrated voice and data conference service; and
Collaboration service.

Conference call refers to a telephone call with three or more participants in the conversation. The conference call can be implemented by having one host or moderator call each participant, or by providing a telephone number for accessing the conference call as well as other required information such as passwords, Personal Identification Numbers (PIN), conference codes, etc. to be used by each participant for joining the conference call. Conference calls connect the participants through conference bridges as defined below.

Conference bridge refers to servers with capabilities to answer multiple telephone calls simultaneously and to perform functions just like a telephone. Conference bridge allows multiple participants to converse with each other. For example, if a corporation sets up a conference call to announce the latest financial results to owners, then the conference call can be set up with an access number, a participant code, required password, etc. The corporation (e.g., a host) then provides each owner with the access number and all other required information to join the conference bridge. The owners then dial the conference access number and enter the participant code, the password, etc. and join the conference bridge. A company can own its own conference bridge or subscribe to a teleconferencing service. A teleconference service refers to a conference call service with the conference bridge being provided by a teleconferencing service provider such as the telephone company. If the corporation in the example above contracts with the telephone company for providing the conference bridge, then the telephone company provides the teleconference service.

Integrated voice and data conference service refers to a conference service where participants transmit and receive both voice and data packets simultaneously. For example, the host can speak to all the participants while they are watching presentation material posted to a shared website.

Collaboration service refers to a service that allows participants e.g., co-workers, customers, etc. to share a web page and conduct multi-user meetings, conferences, etc. For example, a design team for a product may have participants in different locations. A shared web page with a collaboration service may be used to reduce errors, to keep versions of the design for the product, to set timelines for the project, to reduce cost associated with travel by having web based design reviews, etc. However, design teams such as in the above example often involve multiple corporations such as vendors, suppliers, etc. A subset of the design team e.g., participants from a particular supplier, may need to have access to documents on the web site but the documents may not be appropriate for sharing with the participants from other corporations such as competitor suppliers. Therefore, there is a need for a method that enables the host to post visual material to a shared website but allow a specified set of participants to view some segments marked as private.

In one embodiment, the current invention discloses a method and apparatus for restricting visual materials in conference services. For example, the customer subscribes to a service with integrated data and voice conferencing capabilities and collaboration services. The service provider enables the subscriber of the service to create and view a list of participants for a conference and to publish visual material to a web site shared by participants. The service provider also enables the subscriber to restrict segments of the visual material to particular subsets of participants of the conference. The subscriber marks the visual material as either accessible by all participants or private. The subscriber then determines the subset of participants that may view visual material marked as private.

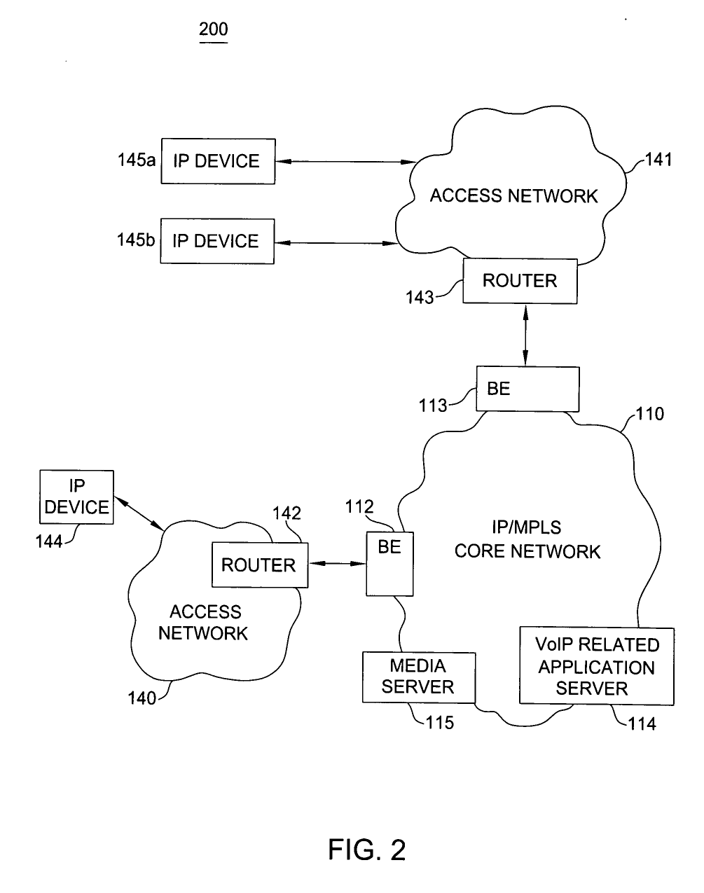

FIG. 2 illustrates an exemplary network 200 with one embodiment of the present invention for restricting visual material for conference services. For example, a customer is using the IP device 144 to access the IP services such as VoIP and SoIP services. IP device 144 is connected to the access network 140. The access network 140 contains a gateway router 142. The gateway router is connected to the IP/MPLS core network 110 through the border element 112. The VoIP application server 114 is in the IP/MPLS core network. In one embodiment, the service provider utilizes the application server 114 to implement the present invention for enabling the customer to host a conference, and to post visual material to a shared web site while allowing the host to specify a set of participants that may view certain segments of the visual material.

Furthermore, other participants are using IP devices 145a and 145b to access the IP services and to join the conference call. The IP devices 145a and 145b are connected to the access network 141. The access network 141 contains a gateway router 143. The gateway router is connected to the IP/MPLS core network 110 through the border element 113.

For example, a customer with an IP device 144 accesses the service to setup a conference call. The customer sets up the conference call e.g., schedule, passwords, and a list of participants. In one embodiment, the host may mark visual materials as either shared or private, and posts the visual materials to a shared web site. Specifically, the host may create registered sets (one or more subsets of participants) for viewing visual materials marked as private. When the participants using IP devices 145a and 145b join the conference, the participants may view visual material in accordance with the designations assigned by the host.

The application server 114 utilizes the media server 115 for media related functions, such as providing responses to customer request in a format compatible with the receiving device used by the customer, handling and terminating media streams, and providing services such as announcements, bridges, etc. For the example above, the application server 114 receives the calls from the participants and engages the media server 115 for providing the visual materials in a format compatible with the receiving devices 145a and 145b. Note that only the network elements used to describe the invention are illustrated in FIG. 2. It is not intended to show all network elements used to deliver a VoIP or SoIP service.

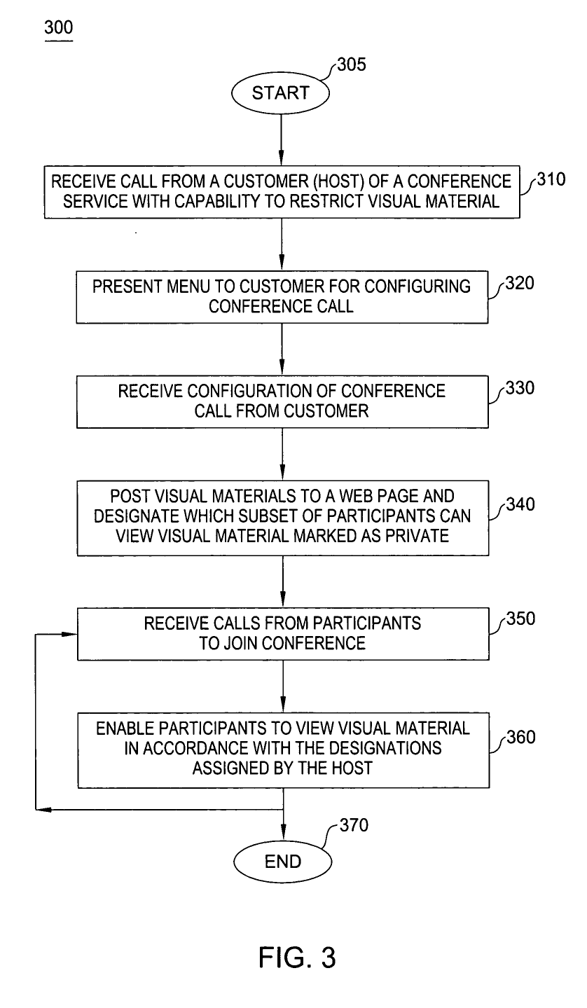

FIG. 3 illustrates a flowchart of one embodiment of the method 300 for restricting visual material for conference services. For example, a service provider can enable a customer to subscribe to a conference service with capability that enables the host to restrict visual material. The service provider implements the present invention to enable a host of a conference, to create and view a participant list, to mark visual materials as either shared or private, to post visual materials to a shared web site, to create registered sets (subsets of participants) for viewing visual materials marked as private and to designate which subsets of participants or registered sets can view each visual material marked as private. Method 300 starts in step 305 and proceeds to step 310.

In step 310, method 300 receives calls from a customer (e.g., a host) of a conferencing service with capability to restrict visual material. For example, a customer dials an access number such as a toll free number for the conference service. The service provider provides the access number to the customer when the customer subscribes for the conference service.

In step 320, method 300 presents a menu to the customer for configuring the conference call. For example, the service provider provides a menu that has multiple levels of participants e.g., managers, executives, employees, vendors and a menu for restricting visual material by levels. In another example, the service provider provides a menu for, creating participant lists, creating subsets of the participant lists, determining which subsets of participant lists can view each visual material marked as private, etc. The service provider determines the implementation for the conference call.

In step 330, method 300 receives a configuration for a conference from a host (e.g., a customer). For example, a customer sets up a conference call that involves two corporations and designates subsets of participants for members of each corporation.

In step 340, method 300 posts visual materials to a web page and designates which subsets of participants can view visual material marked as private. For the above example, the host may post visual material that is to be shared among all participants or visual material that is to be shared among participants from one corporation. If the visual material is to be shared among participants from one corporation, then the host would not designate the participants from other corporations as being able to view that material and so on.

In step 350, method 300 receives calls from the participants to join a conference. For example, the participants call a conference access number provided by the host and enter a password. The method then proceeds to step 360 to enable the participant to join the conference.

In step 360, method 300 enables the participants to view visual material in accordance with the designations assigned by the host. For example, if the host designated a participant as being able to view all private material on the web page, then the participant may view any material on the web page. In another example, if the host designated another participant as being able to view material that is not marked as private, then this participant may only view shared materials. The method then ends in step 370 or returns to step 350 to receive more calls from other participants.

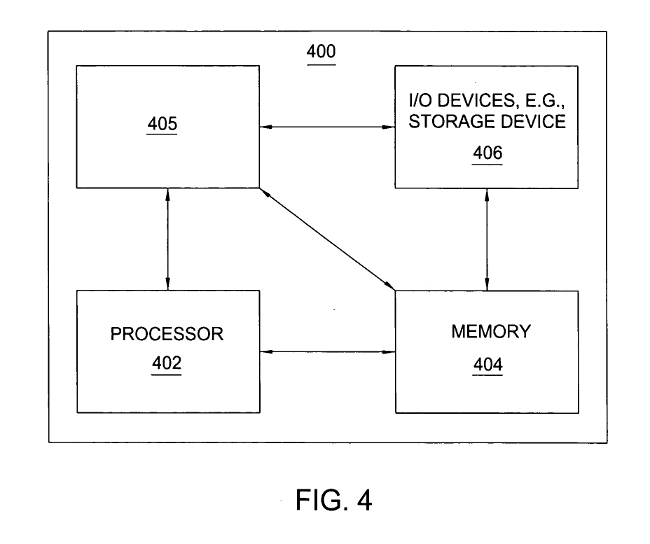

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for restricting visual material for conference services, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module or process 405 for restricting visual material for conference services can be loaded into memory 404 and executed by processor 402 to implement the functions as discussed above. As such, the present method 405 for restricting visual material for conference services (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a conference service in a communication network, comprising:
receiving a request from a subscriber for setting up a conference call; and
receiving a configuration for said conference call from said subscriber, where said configuration comprises a list of participants and at least one subset of said list of participants who is permitted to view a visual material that is marked only for access by said at least one subset of said list of participants.

2. The method of claim 1, wherein said communication network is a Voice over Internet Protocol (VoIP) network or a Service over Internet Protocol (SoIP) network.

3. The method of claim 1, further comprising:
posting said visual material to a web page.

4. The method of claim 1, further comprising:
establishing said conference call.

5. The method of claim 4, further comprising:
receiving a call from one of said participants to join said conference call.

6. The method of claim 5, further comprising:
bridging said one of said participants into said conference call.

7. The method of claim 1, wherein a menu is presented to said subscriber for receiving said configuration.

8. A computer-readable medium having stored thereon a plurality of instructions, the plurality of instructions including instructions which, when executed by a processor, cause the processor to perform the steps of a method for providing a conference service in a communication network, comprising:
receiving a request from a subscriber for setting up a conference call; and
receiving a configuration for said conference call from said subscriber, where said configuration comprises a list of participants and at least one subset of said list of participants who is permitted to view a visual material that is marked only for access by said at least one subset of said list of participants.

9. The computer-readable medium of claim 8, wherein said communication network is a Voice over Internet Protocol (VoIP) network or a Service over Internet Protocol (SoIP) network.

10. The computer-readable medium of claim 8, further comprising:
posting said visual material to a web page.

11. The computer-readable medium of claim 8, further comprising:
establishing said conference call.

12. The computer-readable medium of claim 11, further comprising:
receiving a call from one of said participants to join said conference call.

13. The computer-readable medium of claim 12, further comprising:
bridging said one of said participants into said conference call.

14. The computer-readable medium of claim 8, wherein a menu is presented to said subscriber for receiving said configuration.

15. An apparatus for providing a conference service in a communication network, comprising:
means for receiving a request from a subscriber for setting up a conference call; and
means for receiving a configuration for said conference call from said subscriber, where said configuration comprises a list of participants and at least one subset of said list of participants who is permitted to view a visual material that is marked only for access by said at least one subset of said list of participants.

16. The apparatus of claim 15, wherein said communication network is a Voice over Internet Protocol (VoIP) network or a Service over Internet Protocol (SoIP) network.

17. The apparatus of claim 15, further comprising:
means for posting said visual material to a web page.

18. The apparatus of claim 15, further comprising:
means for establishing said conference call.

19. The apparatus of claim 18, further comprising:
means for receiving a call from one of said participants to join said conference call.

20. The apparatus of claim 19, further comprising:
means for bridging said one of said participants into said conference call.
